(19) United States
(12) Patent Application Publication
(10) Pub. No.: US 2026/0312914 A1
(43) Pub. Date: Oct. 8, 2026

(54) FLOW CONTROL-BASED COMPUTING SYSTEM AND METHOD FOR SWITCHING CONNECTIONS BETWEEN COMPUTING RESOURCES

(71) Applicant: ELECTRONICS AND TELECOMMUNICATIONS RESEARCH INSTITUTE, Daejeon (KR)

(72) Inventors: Daeub KIM, Daejeon (KR); Bup Joong KIM, Daejeon (KR); Chanho PARK, Daejeon (KR); Jongtae SONG, Daejeon (KR); Ji Wook YOUN, Daejeon (KR); Jun Ki LEE, Daejeon (KR); Kyeong-Eun HAN, Daejeon (KR)

(73) Assignee: ELECTRONICS AND TELECOMMUNICATIONS RESEARCH INSTITUTE, Daejeon (KR)

(21) Appl. No.: 19/457,742

(22) Filed: Jan. 23, 2026

(30) Foreign Application Priority Data
Feb. 13, 2025 (KR) 10-2025-0018512

(51) Int. Cl. H04L 47/10; H04L 47/26; H04L 49/253

(52) U.S. Cl. CPC H04L 47/39; H04L 47/266; H04L 49/254

(57) ABSTRACT

A computing system is provided. The computing system may include a first to a third computing resource that transmit and receive a message, data, or a flit based on credits; a switch fabric including a first to a third switch port connected to the first to the third computing resources, respectively; and a fabric manager configured to control the switch fabric to change a one-to-one connection path between the first switch port and the second switch port to a one-to-one connection path between the first switch port and the third switch port. The fabric manager may transmit, to each of the first and second computing resources, a request to stop transmission and reception in order to change the connection path among the plurality of switch ports, and each of the first and second computing resources may stop transmission of the message, the data, or the flit based on the request to stop transmission and reception.

### CROSS-REFERENCE TO RELATED APPLICATIONS

This application claims priority under 35 U.S.C. §119 to Korean

Patent Application No. 10-2025-0018512 filed on Feb. 13, 2025, in the Korean Intellectual Property Office, the disclosure of which is incorporated by reference herein in its entirety.

### BACKGROUND

The present disclosure relates to methods of connection between computing resources, and more particularly, to a computing system and a method for switching connections between computing resources based on flow control.

In fields such as computing for artificial intelligence (AI) or machine learning (ML), clusters in data centers, and supercomputing, a host, an accelerator, and the like use a memory to process data. In order to provide services such as artificial intelligence, autonomous driving, robots, healthcare, virtual/augmented reality, and home networks, cooperation is required not only with a host CPU but also with accelerators such as a GPU, an NPU, and a TPU, which correspond to peripheral devices. Cooperation of such heterogeneous processing devices is becoming increasingly important. In addition, for parallel processing, a plurality of homogeneous computing resources needs to be connected and mutually accessible. Computing resources such as a host, an accelerator, and a memory can directly access each other, or access attached memories thereof, through an interface that allows direct access.

When computing resources directly access each other through an interface that allows direct access, header analysis and retiming of messages, frames, packets, and flits are required for switching. Such header analysis and retiming operations cause latency. In addition, when electrical-signal-based switching is used, there is a limitation on the distance between the computing resources.

Accordingly, when computing resources directly access each other, there is a need for a scheme capable of minimizing latency and overcoming distance limitations between the computing resources.

### SUMMARY

An objective of the present disclosure is to provide a flow control-based computing system and a method for switching connections between computing resources, which minimize latency that occurs during switching between the computing resources.

According to an embodiment of the present disclosure, a computing system includes first to third computing resources configured to transmit and receive a message, data, or a flit based on credits; a switch fabric including first to third switch ports connected to ports of the first to third computing resources, respectively; and a fabric manager configured to control the switch fabric so that a one-to-one connection path between the first switch port and the second switch port is changed into a one-to-one connection path between the first switch port and the third switch port. The fabric manager transmits a stop request to each of the first and second computing resources to change the connection path between the plurality of switch ports, and each of the first and second computing resources may stop transmission of a message, data, or a flit based on the stop request.

A method for switching connections between a plurality of computing resources that transmit and receive a message, data, or a flit based on credits through a switch fabric including a plurality of switch ports, according to an embodiment of the present disclosure, may include: determining, by a fabric manager, a start of switching for changing a connection path between a first switch port connected to a first computing resource and a second switch port connected to a second computing resource into a connection path between the first switch port and a third switch port connected to a third computing resource; transmitting, by the fabric manager, a stop request to each of the first computing resource and the second computing resource; stopping, by each of the first computing resource and the second computing resource, return of credits based on the stop request; and transmitting, by the fabric manager, a switching request to the switch fabric.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a computing system according to an embodiment of the present disclosure.

FIG. 2 is a block diagram illustrating a connection interface of a computing resource according to an embodiment of the present disclosure.

FIG. 3 is a diagram illustrating switching of a connection path between computing resources according to an embodiment of the present disclosure.

FIGS. 4A to 4C are diagrams illustrating a method for switching connections between computing resources according to an embodiment of the present disclosure.

### DETAILED DESCRIPTION

Hereinafter, embodiments of the present disclosure will be described clearly and in detail so that those skilled in the art to which the present disclosure pertains can easily carry out the disclosure.

Components described with reference to the terms unit, module, block, or suffixes such as-or and -er, as well as functional blocks shown in the drawings, may be implemented in the form of software, hardware, or a combination thereof. For example, the software may include machine code, firmware, embedded code, or application software. The hardware may include electrical circuits, electronic circuits, processors, computers, integrated circuits, integrated circuit cores, pressure sensors, inertial sensors, microelectromechanical systems (MEMS), passive elements, or combinations thereof.

In the present document, each of the phrases “A or B”, “at least one of A and B”, “at least one of A or B”, “A, B, or C”, “at least one of A, B, and C”, and “at least one of A, B, or C” may include any one of the items listed together in the relevant phrase, or any possible combination of all of them.

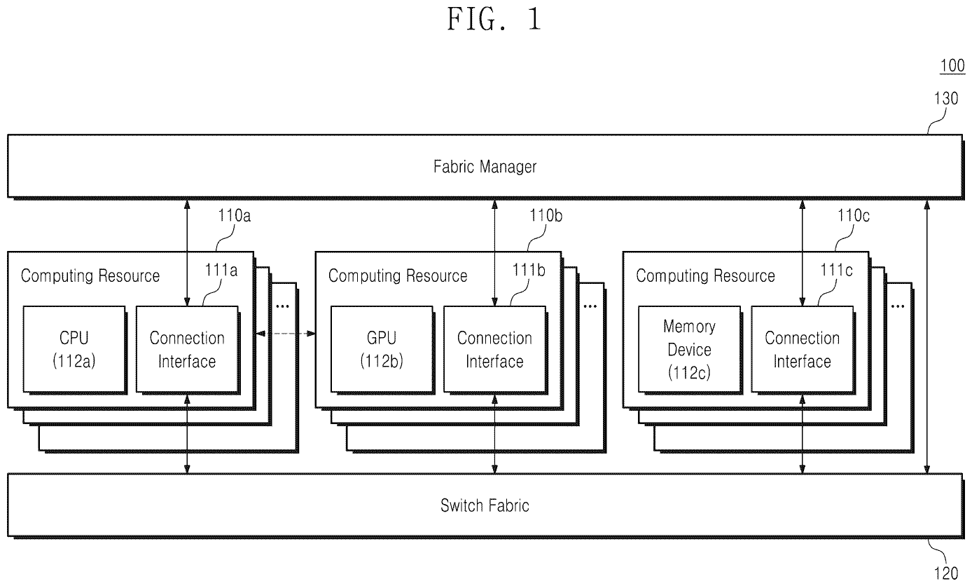

FIG. 1 is a block diagram illustrating a computing system according to an embodiment of the present disclosure.

Referring to FIG. 1, a computing system 100 may include a plurality of computing resources 110a, 110b, and 110c, a switch fabric 120, and a fabric manager 130.

Each of the computing resources 110a, 110b, and 110c may correspond to an element that performs computation or data processing of the computing system 100, or that stores data.

The computing resource 110a may correspond to a host. The computing resource 110a may include at least one central processing unit (CPU) 112a and a connection interface 111a. The CPU 112a may execute an operating system (OS), an application program, and the like. The computing resource 110a may further include a cache and an attached memory.

The computing resource 110b may correspond to an accelerator, which is a peripheral device of the host. The computing resource 110b may include at least one graphics processing unit (GPU) 112b and a connection interface 111b. The computing resource 110b may provide high-speed processing or high-speed computation for specific data. Depending on the type of data being processed, the computing resource 110b may include not only the GPU 112b but also specialized processors such as a neural network processing unit (NPU), a tensor processing unit (TPU), or a field programmable gate array (FPGA). By efficiently processing specialized data at the request of the host, the computing resource 110b can enhance computing performance of the computing system 100. The computing resource 110b may further include a cache and an attached memory.

The computing resource 110c may be a peripheral device of the host and may correspond to a fabric-attached memory, a memory expander, or a memory pool of the switch fabric 120. The computing resource 110c may include a memory device 112c and a connection interface 111c. The memory device 112c may include a memory controller and a memory that stores data under control of the memory controller. Data processed by the host or the accelerator may be loaded into the computing resource 110c. The memory device 112c may include a volatile memory such as RAM (random access memory) or SRAM (static random access memory), or a nonvolatile memory including at least one of a flash memory type, a hard disk type, a multimedia card micro type, a card-type memory (e.g., SD or XD memory), a ROM (read-only memory), an EEPROM (electrically erasable programmable ROM), or a PROM (programmable ROM).

The computing resources 110a and 110b may access not only their own attached memories but also the memory of the computing resource 110c and memories of other computing resources 110a and 110b, which are not themselves, as if they were their own attached memories by being memory-mapped on a memory-address basis (e.g., byte-addressable).

The computing system 100 may further include various computing resources in addition to the host, accelerator, and memory pool. The computing system 100 may further include a plurality of homogeneous computing resources. For example, the computing system 100 may further include a plurality of CPUs, a plurality of accelerators, a plurality of memories, or storage devices. The computing system 100 may include L computing resources 110a, M computing resources 110b, and N computing resources 110c. A switch or the switch fabric 120 may provide connections for each of the L computing resources 110a, the M computing resources 110b, and the N computing resources 110c included in the computing system 100.

Each of the computing resources 110a-110c may include corresponding connection interfaces 111a, 111b, and 111c. Each of the connection interfaces 111a-111c provides a connection between the corresponding computing resource 110a-110c and the outside. Each of the connection interfaces 111a-111c may be connected to the switch fabric 120.

The switch fabric 120 may provide connections between the computing resources 110a-110c. The switch fabric 120 may provide one-to-one connections between the connection interfaces 111a-111c. For example, the switch fabric 120 may one-to-one connect the connection interface 111a and the connection interface 111b. The connection interface 111a and the connection interface 111b that are connected one-to-one may transmit and receive data to and from each other. By providing a one-to-one connection between the connection interface 111a and the connection interface 111b, the switch fabric 120 may omit header analysis and retiming, which were required in conventional switch fabrics to determine a source or destination of a message, data, or a flit.

The switch fabric 120 may be an optical switch that uses an optical signal as an input/output signal, such as an optical switch fabric or an optical circuit switch (OCS). When the switch fabric 120 uses an optical signal as an input/output signal, the switch ports included in the switch fabric 120 may be optical ports. When the switch fabric 120 is implemented as an optical switch, the connection interfaces 111a-111c may include optical transceivers for optical-electrical and electrical-optical conversion. A physical layer of each of the connection interfaces 111a-111c may be configured to be suitable for optical transmission and reception.

The switch fabric 120 may also be an electrical switch such as an NVLink switch fabric or a CXL switch fabric. In this case, because the switch fabric 120 provides one-to-one connections between the connection interfaces 111a-111c, header analysis and retiming may be omitted.

According to embodiments of the present disclosure, the fabric manager 130 may control the switch fabric 120 based on credits to establish or change connections between the computing resources 110a-110c. The computing resources 110a-110c use credits during data transmission. For example, when the computing resource 110a transmits information related to a request or a response of a dedicated protocol channel to the computing resource 110b through a message, data, or a flit, a credit of the corresponding dedicated protocol channel is deducted. A credit of the dedicated protocol channel of the computing resource 110a is returned by the computing resource 110b after normal reception of a message, data, or a flit of the corresponding protocol and completion of processing of the corresponding channel information. When the computing resource 110a exhausts credits, transmission of a message, data, or a flit of the dedicated protocol channel by the computing resource 110a may be restricted until the computing resource 110b returns credits. The computing resource 110b may return credits whenever it becomes capable of receiving a message, data, or a flit of the dedicated protocol channel (e.g., when space becomes available in a receive buffer of the corresponding protocol channel). When transmitting a message, data, or a flit between the computing resources 110a-110c, the fabric manager 130 may exchange credit management information with the computing resources 110a-110c. Meanwhile, one flit may correspond to one or more protocol channels. For example, a single flit may include information related to requests or responses of a first protocol channel and a second protocol channel among a plurality of protocol channels.

The fabric manager 130 may control the switch fabric 120 to change a connection path between the computing resources 110a-110c based on requests in the computing resources 110a-110c. Under control of the fabric manager 130, a one-to-one connection path provided by the switch fabric 120 between the computing resources 110a-110c may be changed. The fabric manager 130 may change the connection path between the computing resources 110a-110c based on credit control of specific protocol channels for messages, data, or flits of each of the computing resources 110a-110c.

The computing system 100 may allow the switch fabric 120 to provide one-to-one connections between the computing resources 110a-110c using optical signals, thereby overcoming distance limitations between the computing resources 110a-110c. As a result, distance scalability beyond rack-scale can be achieved. While using optical signals, a flow-control-based protocol using credits may be used for one-to-one connections between the computing resources. Thus, specific protocols of messages, data, or flits may not be affected by changes from conventional computing-resource connection schemes, and changes to related logic may be minimized.

A connection interface between the computing resources 110a-110c may be composed of multiple channels for a specific protocol of messages, data, or flits. Each of the plurality of channels may be determined depending on channel direction (e.g., Master-to-Subordinate or Host-to-Device) and the type of transaction, request, response, or data to be transmitted, such as an M2S Request (Req), an M2S Request with Data (RwD), an M2S Back-Invalidate Response (BIRsp), an S2M No Data Response (NDR), an S2M Data Response (DRS), a D2H Request, a D2H Response, D2H Data, an H2D Request, an H2D Response, and H2D Data. The computing resources 110a-110c may transmit and receive request and response messages, data, or flits through corresponding channels.

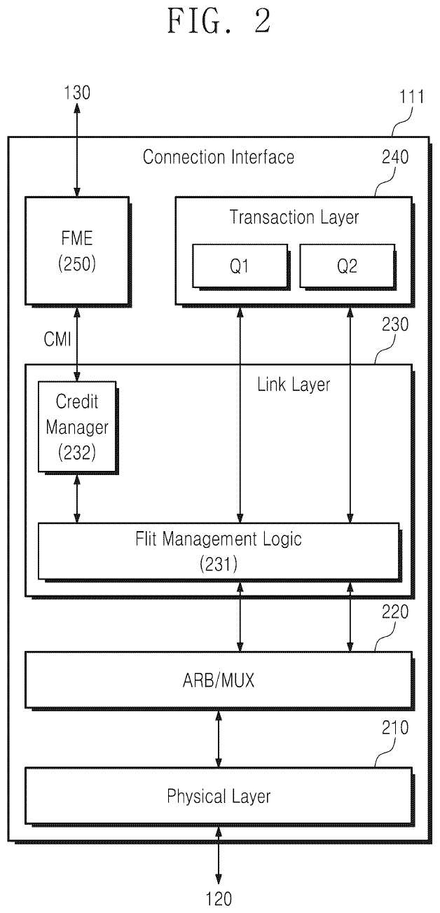

FIG. 2 is a block diagram illustrating a connection interface of a computing resource according to an embodiment of the present disclosure.

Referring to FIG. 2, the connection interface 111 may include a physical layer 210, an ARB/MUX layer 220, a link layer 230, and a transaction layer 240.

The physical layer 210 may convert data into an electrical or optical signal and transmit the data to the outside through a physical medium, or may receive an electrical or optical signal from the outside. The physical layer 210 defines physical characteristics such as a transmission rate and a frequency during data transmission, and may be responsible for hardware-level communication between different connection interfaces 111. The physical layer 210 may establish a connection with a remote physical layer through dedicated lines to ports of the switch fabric 120. When the switch fabric 120 is an optical circuit switch that transmits and receives optical signals, the physical layer 210 may include an optical transceiver. The optical transceiver may convert an optical signal into an electrical signal or convert an electrical signal into an optical signal.

The ARB/MUX layer 220 may perform arbitration or multiplexing of data streams or requests. When multiple protocol channels simultaneously request data transmission at the transmitting side, the ARB/MUX layer 220 may determine priorities and prevent collisions. The ARB/MUX layer 220 may integrate multiple data streams into one physical channel for transmission. A receiving side may restore the integrated physical channel into multiple protocol channels.

The link layer 230 may manage data flow and handle errors to ensure reliability and efficiency of data transmission. The link layer 230 may include flit management logic 231 that manages messages, data, or flits. The flit management logic 231 may divide a packet of each protocol channel in the transaction layer 240 into flits, which are smaller units, when transmitting the packet. A flit formed by the flit management logic 231 may be transmitted outside the connection. The flit management logic 231 may combine received flits and restore the original packet. The link layer 230 may perform flow control in units of flits to synchronize a transmission rate and a reception rate.

The link layer 230 may further include a credit manager 232. The credit manager 232 may perform flow control in units of flits using credits. The credit manager 232 may exchange credit management information with the fabric manager 130 through a fabric management endpoint 250 in the connection interface 111. The credit manager 232 may control and manage credit information of each channel transmitted and received between two connection interfaces of each computing resource or the switch.

The transaction layer 240 may manage high-level requests and responses. The transaction layer 240 may convert an application-layer or software request into a packet format and deliver the packet to the link layer. The transaction layer 240 may manage transmit queues and receive queues for specific protocol channels of messages, data, or flits. Each channel in the transaction layer 240 is configured independently, and protocol information of each channel may be stored and managed in packet form according to the protocol of each channel. The protocol information may be stored and managed in a protocol channel queue. In the transaction layer 240, protocol information may be transmitted and received through management of the transmit queues and the receive queues.

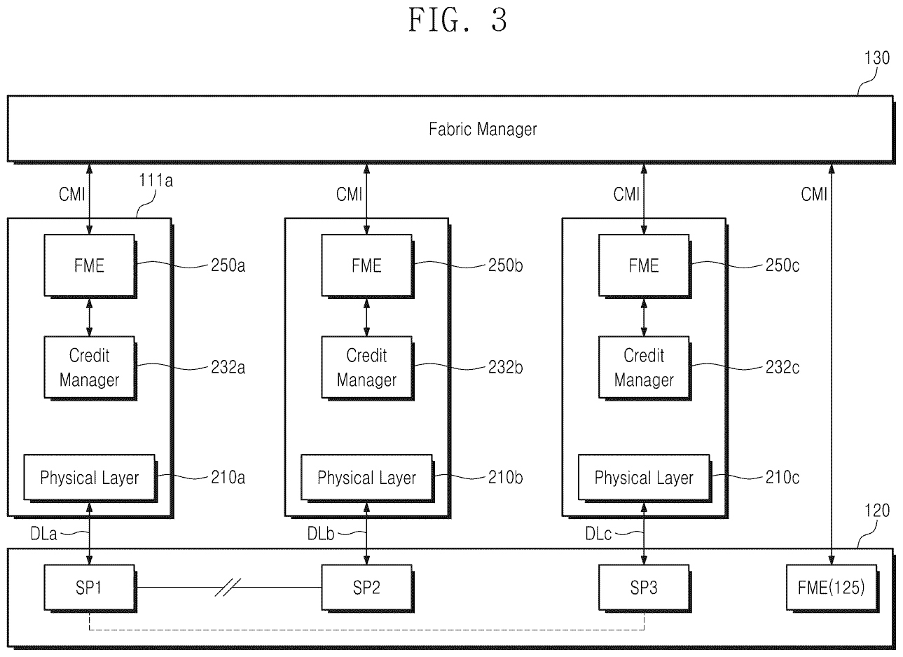

FIG. 3 is a diagram illustrating switching of connections between computing resources according to an embodiment of the present disclosure.

Referring to FIG. 3, a switch fabric 120 may include a plurality of switch ports SP1, SP2, and SP3.

A switch port SP1 may be connected to a physical layer 210a of a connection interface 111a of a computing resource through a dedicated line DLa. A switch port SP2 may be connected to a physical layer 210b of a connection interface 111b through a dedicated line DLb. A switch port SP3 may be connected to a physical layer 210c of a connection interface 111c through a dedicated line DLc. Each of the dedicated lines DLa to DLc may provide sufficient bandwidth. Each of the dedicated lines DLa to DLc may be configured to be bidirectional for input and output.

When the switch fabric 120 is an optical circuit switch, each of the switch ports SP1 to SP3 may be an optical port. The switch ports SP1 to SP3 may be connected in a one-to-one manner. For example, the switch port SP1 may be connected in a one-to-one manner to the switch port SP2. In this case, the connection interface 111a may communicate in a one-to-one manner with the connection interface 111b. During one-to-one data communication via an optical signal between the connection interface 111a and the connection interface 111b, the switch fabric 120 may omit header analysis and retiming. The connection interface 111a and the connection interface 111b may communicate at a high speed through an optical signal. In this case, a one-to-one connection path that bidirectionally passes through the dedicated line DLa, the switch port SP1, the switch port SP2, and the dedicated line DLb may be established between the connection interface 111a and the connection interface 111b.

The fabric manager 130 may exchange fabric management information including credit management information with credit managers 232a, 232b, and 232c corresponding to the connection interfaces 111a to 111c, respectively. The fabric manager 130 may exchange credit management information (CMI) via fabric management endpoints 250a, 250b, and 250c included in the connection interfaces 111a to 111c, respectively. The fabric manager 130 may exchange path information, switching information, and credit management information CMI of the switch fabric 120 via a fabric management endpoint 125 included in the switch fabric 120.

Unique identifiers may be assigned to each of the computing resources 110a to 110c corresponding to the connection interfaces 111a to 111c, the switch fabric 120, and the fabric manager 130, to distinguish each device. The identifiers may be given as specific values representing physical devices or specific values representing logical logic devices. As one example of the identifiers, an identifier FMID1 may be given to the fabric manager 130. An identifier HID2 may be given to the computing resource 110a. Identifiers DID2 and DID3 may be given to the computing resource 110b and the computing resource 110c, respectively. An identifier SID5 may be given to the switch fabric 120. The identifiers are exemplary, and the identifiers may be given to each device in an appropriate manner to distinguish the devices.

Assume that a connection is established between the switch port SP1 and the switch port SP2 and that the computing resource 110a and the computing resource 110b transmit and receive a message, data, or a flit based on flow control. Communication between the computing resource 110a and the computing resource 110b may be performed based on flow control. Protocol channel information of requests/responses and data related to read and write operations between the computing resources 110a and 110b, which is managed in transaction layers 240 of the connection interfaces 111a and 111b, may be transmitted and received in the form of flits. At this time, credit information may be written into a credit field and transmitted and received between the computing resources 110a and 110b. Return of credits may be performed through channel credit information in the credit field.

When the computing resource 110a and the computing resource 110b are connected to each other and the computing resource 110a needs to access the computing resource 110c, after a connection between the connection interface 111a and the connection interface 111b is terminated, a connection needs to be established between the connection interface 111a and the connection interface 111c. By switching between the switch ports SP1 to SP3, a connection between the port SP1 and the switch port SP2 may be disconnected, and a connection between the switch port SP1 and the switch port SP3 may be established.

The fabric manager 130 may determine a start of switching for changing a connection path. The fabric manager 130 may determine a change of the connection path according to requests of the computing resources.

The fabric manager 130 may transmit fabric credit messages FABRIC_CREDIT_CTL(HID2, SP1, STOP) and FABRIC_CREDIT_CTL(DID3, SP2, STOP), which include a stop request, to each of the connection interface 111a and the connection interface 111b. The connection interface 111a may stop transmission of flits based on FABRIC_CREDIT_CTL(HID2, SP1, STOP). Credit management information may be delivered through a fabric credit message.

In this case, the connection interface 111a may stop flit transmission through a credit return suppression method. When the credit return suppression method is applied, the connection interface 111a no longer returns credits. At this time, transmission of a specific protocol channel of flits may be completed by credits that have already been returned. When there is no longer any credit returned to the connection interface 111b (that is, when all credits are exhausted), Tx credit=0, and transmission of flits of all protocol channels may be stopped. That is, when all held credits exist, transmission of requests, responses, and data for each channel may be performed until the credits are exhausted. When valid flit transmission and reception are stopped by the credit return suppression method, transmission and reception of requests, responses, and data for each channel are possible in each connection interface as much as the remaining credits. In the credit return suppression method, since credit management information according to the fabric credit message FABRIC_CREDIT_CTL has a lower priority than credit return information already exchanged in each connection interface, transmission and reception of flits may be stopped after transmission and reception of the flits are completed by credits that have already been returned.

Meanwhile, the connection interface 111a may also stop valid flit transmission through a credit invalidation method. In this case, based on reception of the fabric credit message, the connection interface 111a no longer returns credits, and all credits that have already been returned and are held are invalidated to 0. Likewise, the connection interface 111b no longer returns credits, and all credits currently held are invalidated to 0. When transmission and reception of all protocol channels of flits are stopped by the credit invalidation method, even if credits already held exist in a connection interface that performs flit transmission and reception, all the credits are invalidated, and transmission and reception of flits may be immediately stopped. In the credit invalidation method, since credit management information according to a fabric credit message FABRIC_CREDIT_CTL has a higher priority than credit information exchanged in each connection interface, transmission and reception of flits may be immediately stopped.

The connection interface 111a and the connection interface 111b may transmit fabric credit messages FABRIC_CREDIT_CTL(HID2, SP1, READY) and FABRIC_CREDIT_CTL(DID3, SP2, READY), which indicate that switching preparation has been completed, to the fabric manager 130.

Based on reception of the fabric credit messages FABRIC_CREDIT_CTL(HID2, SP1, READY) and FABRIC_CREDIT_CTL(DID3, SP2, READY), which include switching preparation completion responses from each of the connection interface 111a and the connection interface 111b, the fabric manager 130 may transmit a fabric credit message FABRIC_CREDIT_CTL(SID5, SWITCH), which changes the connection path, to the switch fabric 120. The fabric credit message FABRIC_CREDIT_CTL(SID5, SWITCH) may include a changed path SP1-SP3.

Based on the received fabric credit message, the switch fabric 120 may switch a connection between the switch port SP1 and the switch port SP2, corresponding to a first connection path, to a connection between the switch port SP1 and the switch port SP3, corresponding to a second connection path. That is, a connection between ports may be switched from the first connection path to the second connection path.

Based on a connection established between the switch port SP1 and the switch port SP3, the switch fabric 120 may transmit a fabric credit message FABRIC_CREDIT_CTL(SID5, READY), which indicates that use of the new path is ready, to the fabric manager 130. The fabric credit message FABRIC_CREDIT_CTL(SID5, READY) may include the changed path SP1-SP3.

Based on the fabric credit message FABRIC_CREDIT_CTL(SID5, READY), the fabric manager 130 may transmit fabric credit messages FABRIC_CREDIT_CTL(HID2, SP1, START) and FABRIC_CREDIT_CTL(DID4, SP3, START), which include a request to start transmission and reception through the new path, to the connection interface 111a and the connection interface 111c, respectively.

Each of the connection interface 111a and the connection interface 111c may perform initialization between the connection interface 111a and the connection interface 111c based on reception of the fabric credit messages FABRIC_CREDIT_CTL(HID2, SP1, START) and FABRIC_CREDIT_CTL(DID4, SP3, START).

Each of the connection interface 111a and the connection interface 111c may transmit fabric credit messages FABRIC_CREDIT_CTL(HID2, Normal) and FABRIC_CREDIT_CTL(DID4, Normal), which include a normal response, to the fabric manager 130 based on successful completion of initialization.

Based on reception of the fabric credit messages FABRIC_CREDIT_CTL(HID2, Normal) and FABRIC_CREDIT_CTL(DID4, Normal), the fabric manager 130 may determine completion of switching for changing the connection path.

The computing resource 110a and the computing resource 110c may perform transmission and reception of a message, data, or a flit based on flow control through the newly connected path.

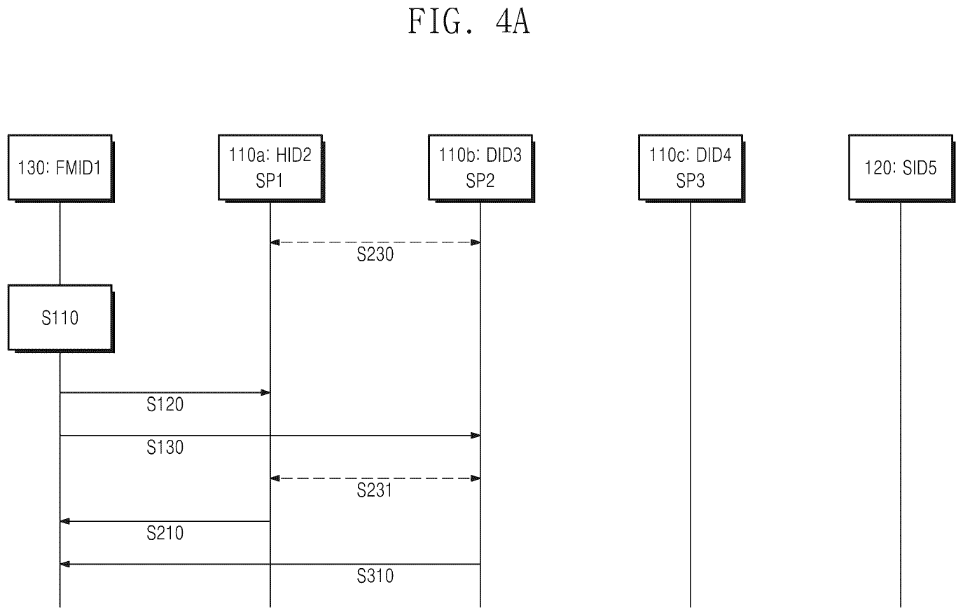

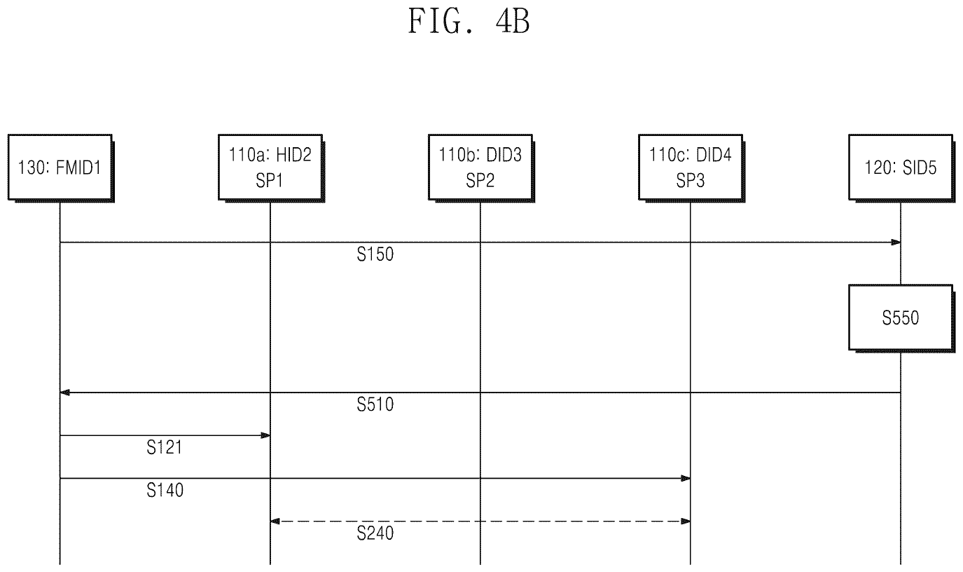

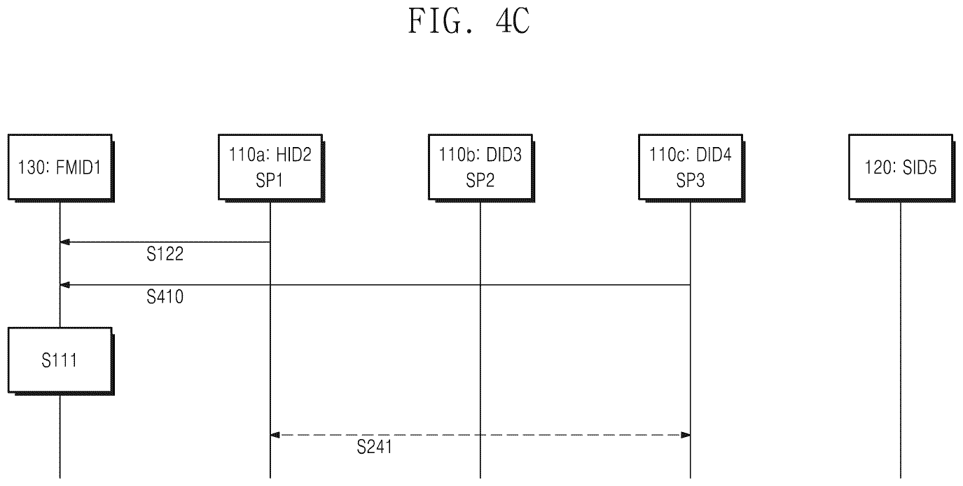

FIGS. 4A to 4C are diagrams illustrating a method for switching connections between computing resources according to an embodiment of the present disclosure.

Referring to FIGS. 4A to 4C, a connection between a computing resource 110a and a computing resource 110b is disconnected, and a new connection may be established between the computing resource 110a and a computing resource 110c.

An identifier of the fabric manager 130 is FMID1, an identifier of the computing resource 110a is HID2, an identifier of the computing resource 110b is DID3, an identifier of the computing resource 110c is DID4, and an identifier of the switch fabric 120 is SID5. The computing resource 110a is connected to a switch port SP1 of the switch fabric 120, the computing resource 110b is connected to a switch port SP2 of the switch fabric 120, and the computing resource 110c is connected to a switch port SP3 of the switch fabric 120.

A method for switching connections between computing resources may include a step S230 of performing transmission and reception of a message, data, or a flit based on flow control using credits between the computing resource 110a and the computing resource 110b. In step S230, the computing resource 110a may transmit a message, data, or a flit to the computing resource 110b using transmit credits, and the computing resource 110b may return credits to the computing resource 110a when receive capacity becomes available. Likewise, the computing resource 110b may transmit a message, data, or a flit to the computing resource 110a using transmit credits, and the computing resource 110a may return credits to the computing resource 110b when receive capacity becomes available. At this time, a connection has been established between the switch port SP1 and the switch port SP2. The switch fabric 120 may provide signal transmission between the switch port SP1 and the switch port SP2 without performing header analysis or retiming of a message, data, or a flit.

The method for switching connections between computing resources may include a step S110 of determining, by the fabric manager 130, a start of switching for changing a connection path from a connection between the switch port SP1 and the switch port SP2 to a connection between the switch port SP1 and the switch port SP3.

The method for switching connections between computing resources may include a step S120 of transmitting, by the fabric manager 130, a request to stop transmission and reception to the computing resource 110a.

The method for switching connections between computing resources may include a step S130 of transmitting, by the fabric manager 130, a request to stop transmission and reception to the computing resource 110b.

The method for switching connections between computing resources may include a step S231 of stopping, by the computing resource 110a and the computing resource 110b, transmission of a message, data, or a flit based on the request to stop transmission and reception.

In step S231, each of the computing resource 110a and the computing resource 110b may include a step of stopping return of transmit credits based on the request to stop transmission and reception.

In step S231, each of the computing resource 110a and the computing resource 110b may include a step of setting transmit credits to 0 based on the request to stop transmission and reception.

The method for switching connections between computing resources may include a step S210 of transmitting, by the computing resource 110a, a switching preparation response based on the stopping of transmission of a message, data, or a flit.

The method for switching connections between computing resources may include a step S210 of transmitting, by the computing resource 110b, a switching preparation response based on the stopping of transmission of a message, data, or a flit.

The method for switching connections between computing resources may include a step S150 of transmitting, by the fabric manager 130, a switching request to the switch fabric 120 based on switching preparation responses received from each of the computing resource 110a and the computing resource 110b.

The method for switching connections between computing resources may include a step S550 of switching, by the switch fabric 120, a connection between the switch port SP1 and the switch port SP2 to a connection between the switch port SP1 and the switch port SP3. That is, switching may be performed by the switch fabric 120.

Meanwhile, in step S550, the switch fabric 120 may disconnect the connection between the switch port SP1 and the switch port SP2 and connect between the switch port SP1 and the switch port SP3 in response to the switching request received from the fabric manager.

The method for switching connections between computing resources may include a step S510 of transmitting, by the switch fabric 120, a transmission/reception preparation response to the fabric manager 130 based on a connection established between the switch port SP1 and the switch port SP3.

The method for switching connections between computing resources may include a step S121 of transmitting, by the fabric manager 130, a request to start transmission and reception to the computing resource 110a based on the transmission/reception preparation response received from the switch fabric 120.

The method for switching connections between computing resources may include a step S140 of transmitting, by the fabric manager 130, a request to start transmission and reception to the computing resource 110c based on the transmission/reception preparation response received from the switch fabric 120.

The method for switching connections between computing resources may include a step S240 of performing, by the computing resource 110a and the computing resource 110c, credit initialization.

The method for switching connections between computing resources may include a step S122 of transmitting, by the computing resource 110a, a normal response to the fabric manager 130 based on successful completion of the credit initialization.

The method for switching connections between computing resources may include a step S410 of transmitting, by the computing resource 110c, a normal response to the fabric manager 130 based on successful completion of the credit initialization.

The method for switching connections between computing resources may include a step S111 of determining, by the fabric manager 130, completion of switching based on normal responses received from each of the computing resource 110a and the computing resource 110c.

After step S111, transmission and reception of a message, data, or a flit based on flow control may be performed between the computing resource 110a and the computing resource 110c.

Meanwhile, various requests and responses transmitted in each step of the method for switching connections between computing resources, including the request to stop transmission and reception, the switching preparation response, the transmission/reception preparation response, the switching request, and the normal response, may be delivered in a fabric credit message.

According to an embodiment of the present disclosure, a flow-control-based computing system and a method for switching connections between computing resources may provide one-to-one connections between computing resources without affecting interface logic or protocols. Accordingly, the switch fabric may omit header analysis of messages, flits, packets, frames, and the like transmitted and received between the computing resources. In addition, since the computing resources are connected in a one-to-one manner, the switch fabric may also omit retiming.

The foregoing description illustrates specific embodiments for implementing the present disclosure. The present disclosure is not limited to the foregoing embodiments, and also includes embodiments that are simply design-changed or can be readily modified. In addition, the present disclosure includes technologies that can be easily modified and implemented using the embodiments. Accordingly, the scope of the present disclosure should not be determined as being limited to the foregoing embodiments, but should be defined by the claims described below and equivalents thereof.

What is claimed is:

1. A computing system comprising:
a first to a third computing resource that transmit and receive a message, data, or a flit based on credits;
a switch fabric including a first to a third switch port connected to ports of the first to the third computing resource, respectively; and
a fabric manager configured to control the switch fabric to switch a one-to-one connection path between the first switch port and the second switch port to a one-to-one connection path between the first switch port and the third switch port,
wherein the fabric manager transmits, to each of the first and second computing resources, a request to stop transmission and reception in order to switch the connection path among the plurality of switch ports, and
the first computing resource and the second computing resource each stop transmission of the message, the data, or the flit based on the request to stop transmission and reception.

2. The computing system of claim 1, wherein the first computing resource stops returning credits of the second computing resource based on the request to stop transmission and reception.

3. The computing system of claim 1, wherein the first computing resource invalidates credits of the first computing resource to zero based on the request to stop transmission and reception.

4. The computing system of claim 1, wherein each of the first computing resource and the second computing resource transmits, to the fabric manager, a switching preparation response based on stopping transmission of flits.

5. The computing system of claim 4, wherein the fabric manager transmits a switching request to the switch fabric based on the switching preparation responses received from the first computing resource and the second computing resource.

6. The computing system of claim 5, wherein the switch fabric disconnects the connection between the first switch port and the second switch port and connects the first switch port and the third switch port based on the switching request.

7. The computing system of claim 6, wherein the fabric manager transmits a transmission/reception start request to each of the first computing resource and the third computing resource.

8. The computing system of claim 7, wherein each of the first computing resource and the third computing resource performs credit initialization based on the transmission/reception start request, and transmits a normal response to the fabric manager based on successful completion of the credit initialization.

9. The computing system of claim 1, wherein each of the first to the third computing resources includes a connection interface, and
wherein the connection interface includes a credit manager configured to transmit and receive credit management information with the fabric manager through a fabric management endpoint.

10. The computing system of claim 9, wherein the credit manager is included in a link layer of the connection interface.

11. The computing system of claim 9, wherein the request to stop transmission and reception is included in the credit management information.

12. The computing system of claim 1, wherein the switch fabric is an optical circuit switch and each of the first to the third switch ports is an optical port.

13. The computing system of claim 12, wherein connection interfaces included in each of the first to the third computing resources include an optical transceiver.

14. A method for switching connections between a plurality of computing resources that transmit and receive a message, data, or a flit based on credits through a switch fabric including a plurality of switch ports, the method comprising:
determining, by a fabric manager, a start of switching for switching a connection path between a first switch port connected to a first computing resource and a second switch port connected to a second computing resource to a connection path between the first switch port and a third switch port connected to a third computing resource;
transmitting, by the fabric manager, a request to stop transmission and reception to each of the first computing resource and the second computing resource;
stopping, by each of the first computing resource and the second computing resource, transmission of the message, the data, or the flit based on the request to stop transmission and reception; and
performing, by the switch fabric, the switching.

15. The method of claim 14, wherein stopping transmission of the message, the data, or the flit includes stopping, by the first computing resource, return of credits to the second computing resource based on the request to stop transmission and reception.

16. The method of claim 14, wherein stopping transmission of the message, the data, or the flit further includes invalidating, by the first computing resource, credits of the first computing resource to zero based on the request to stop transmission and reception.

17. The method of claim 14, further comprising:
transmitting, by each of the first computing resource and the second computing resource, a switching preparation response to the fabric manager based on stopping transmission of the message, the data, or the flit; and
transmitting, by the fabric manager, a switching request to the switch fabric based on the switching preparation responses received from each of the first computing resource and the second computing resource.

18. The method of claim 17, wherein performing the switching includes:
disconnecting, by the switch fabric, the connection between the first switch port and the second switch port based on the switching request; and
connecting, by the switch fabric, the first switch port and the third switch port.

19. The method of claim 14, wherein the switch fabric is an optical circuit switch and each of the first to the third switch ports is an optical port.

20. The method of claim 19, wherein connection interfaces included in each of the first to the third computing resources include an optical transceiver.
